(19) United States
(12) Patent Application Publication
(10) Pub. No.: US 2025/0367797 A1
(43) Pub. Date: Dec. 4, 2025

(54) POWERED RATCHET TOOL WITH A VARIABLE CRANKSHAFT

(71) Applicant: MILWAUKEE ELECTRIC TOOL CORPORATION, Brookfield, WI (US)

(72) Inventor: Kyle A. Marten, Plymouth, WI (US)

(21) Appl. No.: 19/228,499

(22) Filed: Jun. 4, 2025

Related U.S. Application Data
(60) Provisional application No. 63/655,913, filed on Jun. 4, 2024.

(51) Int. Cl. B25B 21/00; B25F 5/00

(52) U.S. Cl. CPC B25B 21/004; B25F 5/001

(57) ABSTRACT

A powered ratchet tool includes a housing and a motor disposed within the housing. The motor has an output shaft rotatable about a first axis. The powered ratchet tool further includes a ratchet mechanism supported by the housing and operably coupled to the output shaft to be driven by the motor. The ratchet mechanism has a crankshaft assembly defining a variable crank radius configured to change an extent of each rotational stroke of the ratchet mechanism. Moreover, the powered ratchet tool includes an output drive operably coupled to the ratchet mechanism to be rotated about a second axis perpendicular to the first axis.

### CROSS-REFERENCE TO RELATED APPLICATIONS

This application claims priority to U.S. Provisional Patent Application No. 63/655,913, filed Jun. 4, 2024, the entire contents of which is incorporated herein by reference.

### FIELD

The present disclosure relates to power tools, and more particularly to powered ratchet tools.

### BACKGROUND

Powered ratchet tools may be driven in a forward direction or an opposite direction to apply torque to a fastener for tightening and loosening operations. Powered ratchet tools are typically powered by an electrical source, such as a DC battery, a conventional AC source, or pressurized air.

### SUMMARY

The present disclosure provides, in one aspect, a powered ratchet tool including a housing and a motor disposed within the housing. The motor includes an output shaft rotatable about a first axis. The powered ratchet tool further includes a ratchet mechanism supported by the housing and operably coupled to the output shaft to be driven by the motor. The ratchet mechanism includes a crankshaft assembly defining a variable crank radius configured to change an extent of each rotational stroke of the ratchet mechanism. Moreover, the powered ratchet tool includes an output drive operably coupled to the ratchet mechanism to be rotated about a second axis perpendicular to the first axis.

The present disclosure provides, in another aspect, a powered ratchet tool including a housing and a motor disposed within the housing. The motor has an output shaft rotatable about a first axis. The powered ratchet tool further includes a crankshaft assembly supported by the housing. The crankshaft assembly has a crankshaft housing operably coupled to the output shaft of the motor for co-rotation about the first axis and a crankshaft at least partially disposed within the crankshaft housing. The crankshaft has an eccentric pin offset from the first axis. The eccentric pin is configured to travel along a first rotational path during operation at a first torque and a second rotational path during operation at a second torque greater than the first torque. The eccentric pin rotates closer to the first axis when traveling along the second rotational path than when traveling along the first rotational path. Moreover, the powered ratchet tool includes an output drive operably coupled to the crankshaft assembly to be rotated about a second axis perpendicular to the first axis.

The present disclosure provides, in another aspect, a powered ratchet tool including a housing and a motor disposed within the housing. The motor has an output shaft rotatable about a first axis. The powered ratchet tool further includes a ratchet mechanism supported by the housing and operably coupled to the output shaft to be driven by the motor. The ratchet mechanism includes a crankshaft assembly having a crankshaft with an eccentric pin offset from the first axis and at least two cam members configured to move relative to each other to change a position of the eccentric pin relative to the first axis, and thereby change an extent of each rotational stroke of the ratchet mechanism. Moreover, the powered ratchet tool includes an output drive operably coupled to the crankshaft assembly to be rotated about a second axis perpendicular to the first axis.

### BRIEF DESCRIPTION OF DRAWINGS

FIG. 1 is a perspective view of a powered ratchet tool according to an embodiment of the present disclosure.

FIG. 2 is a perspective view of the powered ratchet tool of FIG. 1 with portions removed.

FIG. 3 is a cross-sectional view of the powered ratchet tool of FIG. 1, the powered ratchet tool including a ratchet mechanism.

FIG. 4A is a perspective view of a crankshaft housing of the ratchet mechanism of FIG. 3.

FIG. 4B is a cross-sectional view of the crankshaft housing of FIG. 4A.

FIG. 5 is a front view of a crankshaft of the ratchet mechanism of FIG. 3.

FIG. 6A is an exploded view of a cam mechanism of the ratchet mechanism of FIG. 3.

FIG. 6B is another exploded view of the cam mechanism of FIG. 6A.

FIG. 7A is an enlarged cross-sectional view of a yoke housing of the powered ratchet tool of FIG. 1, the powered ratchet tool operated at a low torque value.

FIG. 7B is a perspective view of a portion of the ratchet mechanism of FIG. 3 operated at a low torque value.

FIG. 7C is a cross-sectional view of another portion of the ratchet mechanism of FIG. 3 operated at a low torque value.

FIG. 8A is an enlarged cross-sectional view of the yoke housing of the powered ratchet tool of FIG. 1, the powered ratchet tool operated at a high torque value.

FIG. 8B is a perspective view of the portion of the ratchet mechanism of FIG. 7B operated at a high torque value.

FIG. 8C is a cross-sectional view of the portion of the ratchet mechanism of FIG. 7C operated at a high torque value.

FIG. 9 is a cross-sectional view of the ratchet mechanism of FIG. 3 with a first rotational path, a second rotational path, and a third rotational path.

FIG. 10A is a cross-sectional view of the ratchet mechanism of FIG. 3 operated at a maximum torque value.

FIG. 10B is a cross-sectional view of the ratchet mechanism of FIG. 3 with the first rotational path of FIG. 9, a fourth rotational path, and a fifth rotational path.

FIG. 11 is an enlarged view of a powered ratchet tool according to another embodiment.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

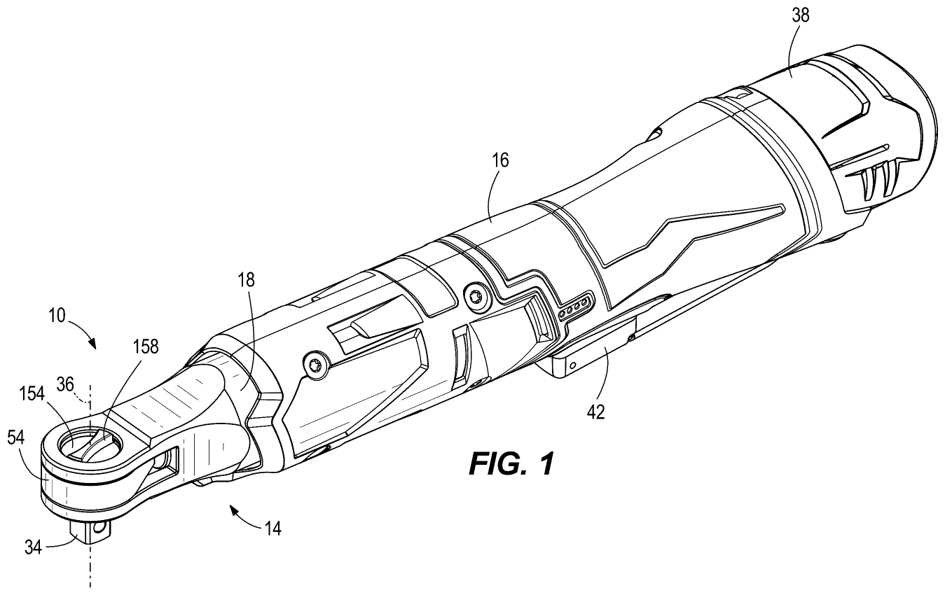

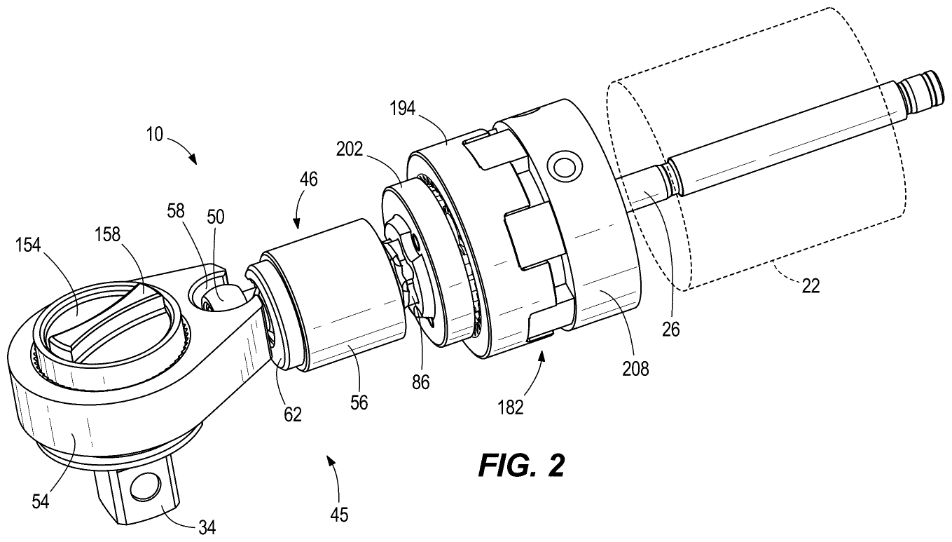

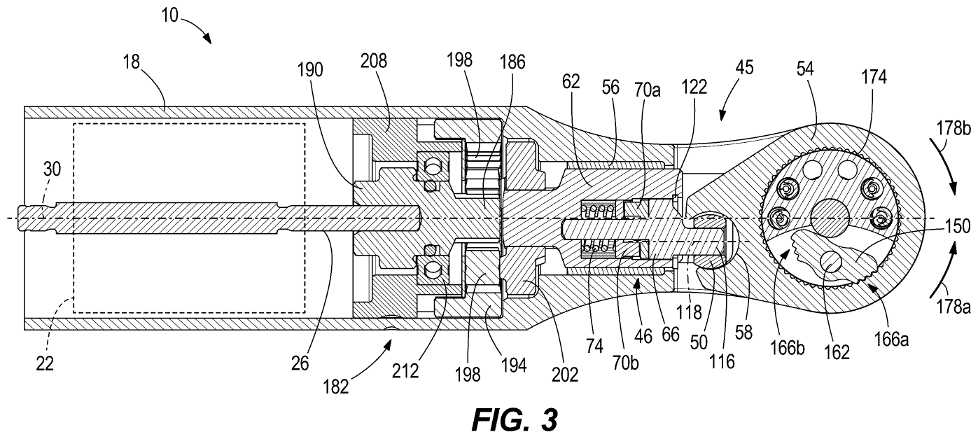

With reference to FIGS. 1 and 2, a powered ratchet tool 10 in accordance with an embodiment of the disclosure includes a housing 14 having a handle housing 16 and a head or yoke housing 18 coupled to and extending from the handle housing 16. The powered ratchet tool 10 further includes a motor 22 that is supported within the housing 14. The motor 22 has an output shaft 26 rotatable about a first axis 30 (FIG. 3) and is configured to provide torque to an output drive 34 rotatably supported by the yoke housing 18 for rotation about a second axis 36 perpendicular to the first axis 30. The motor 22 is preferably a brushless DC motor. In some embodiments, the motor 22 is a surface permanent magnet (SPM) motor including a stator, a rotor, and permanent magnets affixed to or embedded in an exterior surface of the rotor. In other embodiments, the motor 22 is an outer rotor motor, having a rotor that surrounds and rotates about the stator.

In the illustrated embodiment, the ratchet tool 10 includes a battery pack 38 received by a battery receptacle (not shown) formed in the housing 14 opposite the yoke housing 18. The battery receptacle electrically connects the battery pack 38 to the motor 22 (via suitable electrical and electronic components, such as a PCBA containing MOSFETs, IGBTs, or the like). The battery pack 38 may be a 12-volt power tool battery pack that includes three lithium-ion battery cells. Alternatively, the battery pack 38 may include fewer or more battery cells to yield any of a number of different output voltages (e.g., 14.4 volts, 18 volts, etc.). Additionally, or alternatively, the battery cells may include chemistries other than lithium-ion such as, for example, nickel cadmium, nickel metal-hydride, or the like. The ratchet tool 10 also includes an actuator 42 for controlling operation of the ratchet tool 10 (e.g., to energize/de-energize the motor 22). In some embodiments, the actuator 42 may be a push-button that can be depressed into the housing 14 to energize the motor 22. In other embodiments, the actuator 42 may be other types of actuating mechanisms (e.g., slide switch).

With reference to FIGS. 2-6, the powered ratchet tool 10 further includes a ratchet mechanism 45 having a crankshaft assembly 46, a drive bushing 50 coupled to the crankshaft assembly 46, and a yoke 54 through which the output drive 34 extends. A sleeve bearing 56 is provided between the crankshaft assembly 46 and the yoke housing 18 to rotatably support the crankshaft assembly 46. The yoke 54 has a recess 58 in which the drive bushing 50 is arranged to operably couple the crankshaft assembly 46 to the yoke 54. As explained further in detail below, when the crankshaft assembly 46 is rotated, the drive bushing 50 pivots the yoke 54 in a reciprocating manner to drive the output drive 34.

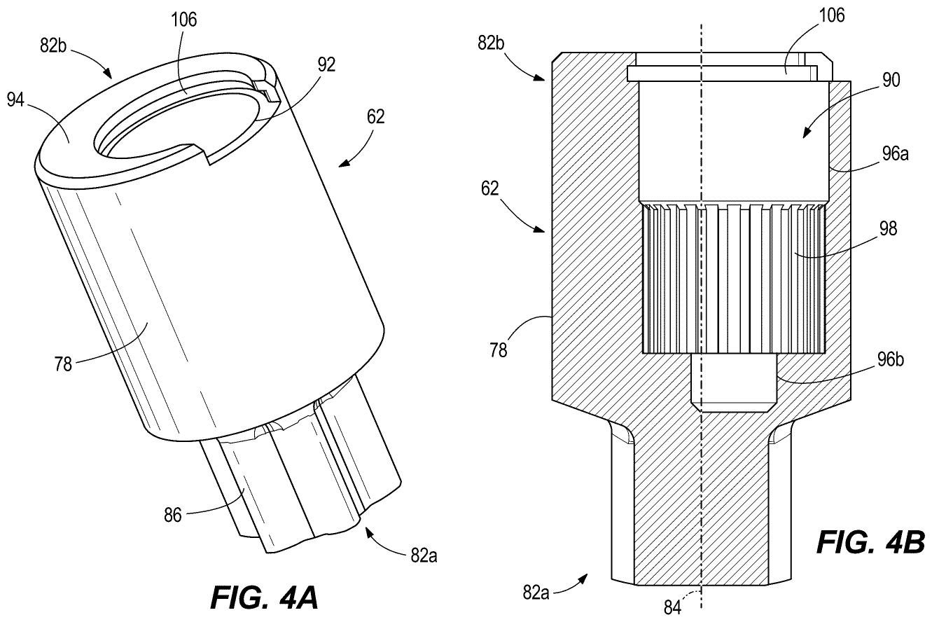

With reference to FIGS. 4A and 4B, the crankshaft assembly 46 includes a crankshaft carrier or crankshaft housing 62, a crankshaft 66, a cam mechanism 68 having a first cam member 70a and a second cam member 70b, and a biasing member or a spring 74 configured to bias the cam members 70a, 70b. The crankshaft housing 62 has a body 78 with a first end 82a and a second end 82b opposite the first end 82a. The body 78 of the crankshaft housing 62 defines a crankshaft axis 84 extending centrally between the first and second ends 82a, 82b of the body 78. The crankshaft axis 84 is coaxial with the first axis 30 of the powered ratchet tool 10. Also, the crankshaft housing 62 has an external gear 86 disposed at the first end 82a of the body 78, a cavity 90 defined within the body 78, and an opening 92 defined within a surface 94 at the second end 82b of the body 78. The opening 92 is configured to permit access to the cavity 90. The cavity 90 of the crankshaft housing 62 is formed by a first hole 96a and a second hole 96b. The spring 74 is positioned within the first hole 96a of the cavity 90. The first hole 96a has a first splined portion 98 that at least extends along a portion of the first hole 96a. The crankshaft housing 62 further includes a groove 106 defined within the body 78 of the crankshaft housing 62. More specifically, the groove 106 is disposed at the second end 82b of the body 78 such that the groove 106 is formed between the cavity 90 and the opening 92.

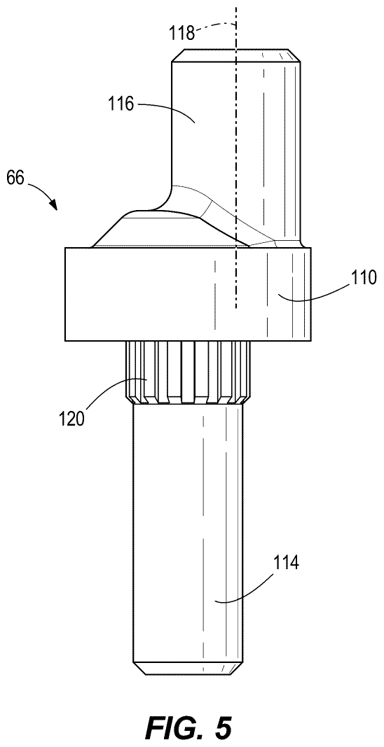

With reference to FIG. 5, the crankshaft 66 includes a body 110, a central shaft 114 extending from the body 110, and an eccentric pin 116 extending from the body 110 in a direction opposite the central shaft 114. The body 110 of the crankshaft 66 is disposed between the central shaft 114 and the eccentric pin 116. The eccentric pin 116 of the crankshaft 66 defines a pin axis 118 oriented at a crank radius CR from the crankshaft axis 84. As explained further in detail below, the position of the eccentric pin 116 may be changed so that the crank radius CR is a variable crank radius. A second splined portion 120 is formed along the central shaft 114 proximate the body 110 of the crankshaft 66. In the illustrated embodiment, the central shaft 114 and the eccentric pin 116 are integrally formed with the body 110 of the crankshaft 66. In other embodiments, the central shaft 114 and the eccentric pin 116 may be separately coupled to the body 110 of the crankshaft 66.

With reference to FIG. 3, the crankshaft 66 is at least partially disposed within the cavity 90 of the crankshaft housing 62. More specifically, the body 110 of the crankshaft 66 is shaped and sized to be disposed within the first hole 96a of the cavity 90. The central shaft 114 of the crankshaft 66 extends through the cavity 90 to be positioned within the second hole 96b of the cavity 90. The eccentric pin 116 of the crankshaft 66 extends out of the cavity 90 of the crankshaft housing 62 and through the opening 92 to be coupled to the drive bushing 50. Also, the crankshaft 66 is arranged within the cavity 90 of the crankshaft housing 62 such that the eccentric pin 116 is offset from the crankshaft axis 84. A clamping ring 122 is disposed within the groove 106 of the crankshaft housing 62 and is configured to engage the crankshaft 66 to secure the crankshaft 66 within the cavity 90. Therefore, the clamping ring 122 prevents the crankshaft 66 from uncoupling the crankshaft housing 62 during operation.

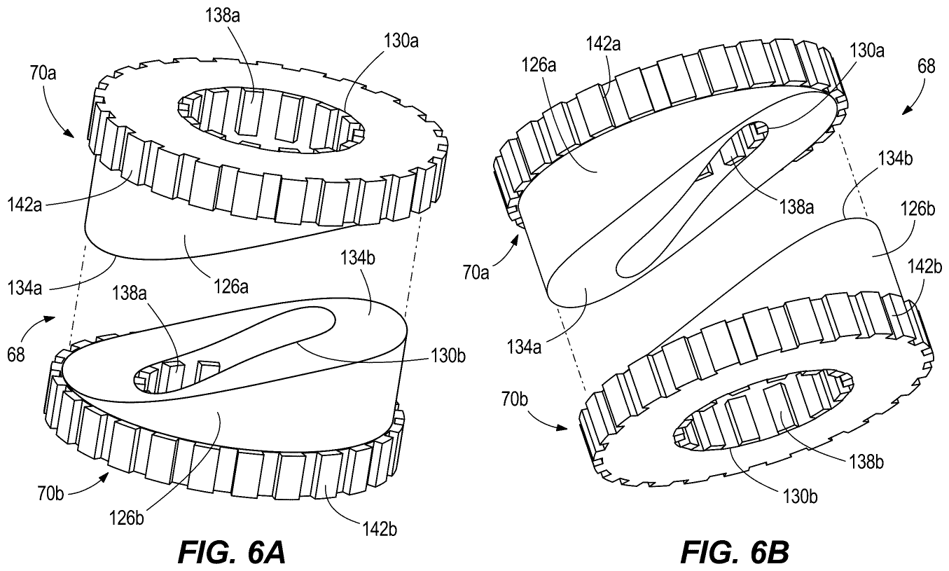

With reference to FIGS. 3, 6A, and 6B, each cam member 70a, 70b includes a body 126a, 126b with a bore 130a, 130b defined therethrough. The body 126a, 126b of each cam member 70a, 70b has a ramped surface 134a, 134b, in which the ramped surfaces 134a, 134b have a corresponding configuration. Also, each cam member 70a, 70b has an internal splined portion 138a, 138b formed along a corresponding bore 130a, 130b and an external splined portion 142a, 142b formed along a corresponding body 126a, 126b. The cam members 70a, 70b are disposed within the first hole 96a of the cavity 90 of the crankshaft housing 62. More specifically, the cam members 70a, 70b are disposed between the body 110 of the crankshaft 66 and the spring 74. Also, the central shaft 114 of the crankshaft 66 extends through the bores 130a, 130b of the cam members 70a, 70b. The spring 74 is configured to bias the cam members 70a, 70b against the body 110 of the crankshaft 66 to press the cam members 70a, 70b against each other or bias the cam members 70a, 70b to be proximate each other. The first and second cam members 70a, 70b are configured to move relative to each other, and thereby rotate the crankshaft 66 to change the position of the eccentric pin 116 relative to the crankshaft axis 84. Changing the position of the eccentric pin 116 may move the pin axis 118 close to the crankshaft axis 84 to decrease the crank radius CR or move the pin axis 118 away from the crankshaft axis 84 to increase the crank radius CR. As such, the crank radius CR is a variable crank radius as a result of the movement of the eccentric pin 116. The external splined portion 142b of the second cam member 70b is configured to engage and cooperate with the first splined portion 98 of the crankshaft housing 62. The internal splined portion 138a of the first cam member 70a is configured to engage and cooperate with the second splined portion 120 of the crankshaft 66.

With reference to FIGS. 2 and 3, the ratchet mechanism 45 further includes a pawl 150 and a forward/reverse switch for the ratchet mechanism 45 in the form of a rotational member 154. The rotational member 154 has a gripping actuator 158 that is accessible through the yoke housing 18. The pawl 150 is provided within the yoke 54 and pivotably secured by a pin 162 that is coupled to the rotational member 154. Also, the pawl 150 has an angled first end 166a with teeth and an angled second end 166b with teeth. The first and second ends 166a, 166b are configured to engage inner teeth 174 of the yoke 54. The gripping actuator 158 can be used to rotate the rotational member 154, and thus, the pawl 150, between a first position corresponding to a first rotational locking direction 178a of the output drive 34 and a second position corresponding to a second rotational locking direction 178b of the output drive 34.

In the first position, the first end 166a of the pawl 150 is configured to engage the inner teeth 174 of the yoke 54 to prevent the output drive 34 from rotating relative to the yoke 54 in the first direction 178a. In other words, the pawl 150 couples the output drive 34 for co-rotation with the yoke 54 in the first direction 178a. The teeth on the first end 166a of the pawl 150 and/or the inner teeth 174 of the yoke 54 are angled to allow the teeth to slip past each other, thereby permitting the yoke 54 to “ratchet” and rotate relative to the output drive 34 in the second direction 178b. In the second position, the second end 166b of the pawl 150 is configured to engage the inner teeth 174 of the yoke 54 to prevent the output drive 34 from rotating relative to the yoke 54 in the second direction 178b. In other words, the pawl 150 couples the output drive 34 for co-rotation with the yoke 54 in the second direction 178b. The teeth on the second end 166b of the pawl 150 and/or the inner teeth 174 of the yoke 54 are angled to allow the teeth to slip past each other, thereby permitting the yoke 54 to “ratchet” and rotate relative to the output drive 34 in the first direction 178a.

With continued reference to FIGS. 2 and 3, the crankshaft assembly 46 of the ratchet mechanism 45 is operably coupled to the output shaft 26 of the motor 22 via a transmission or gear assembly 182 disposed within the yoke housing 18. The gear assembly 182 includes a pinion 186 with a coupling portion 190 extending therefrom, a ring gear 194, a plurality of planet gears 198 arranged to mesh with the ring gear 194, and a planet carrier 202. The pinion 186 is rotatably coupled to the output shaft 26 of the motor 22 for co-rotation about the first axis 30 since the coupling portion 190 is connected to the output shaft 26. The output shaft 26 of the motor 22 and the coupling portion 190 of the pinion 186 may be connected by cooperating splined portions, a key and keyway geometry, or other suitable coupling mechanisms. The ratchet tool 10 further includes a bearing holder 208 disposed within the yoke housing 18 and configured to support a bearing 212 that is provided to rotatably support the pinion 186.

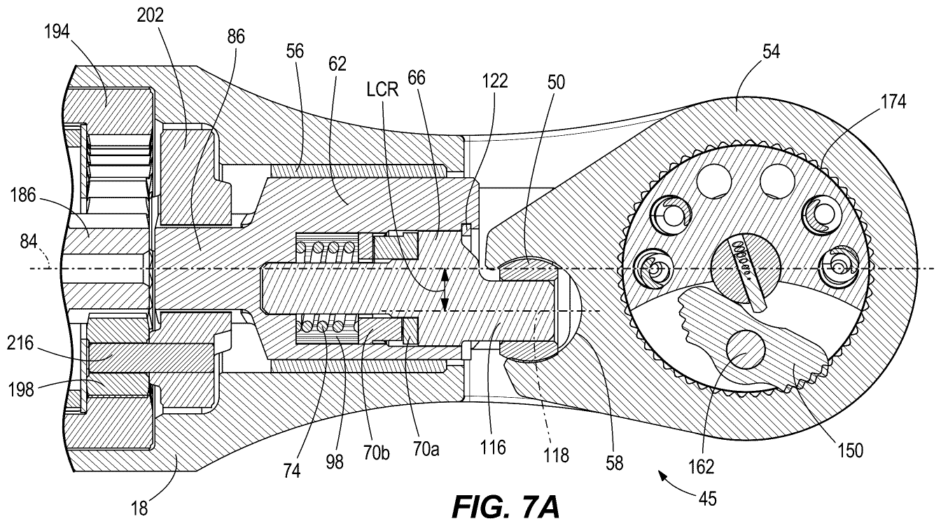

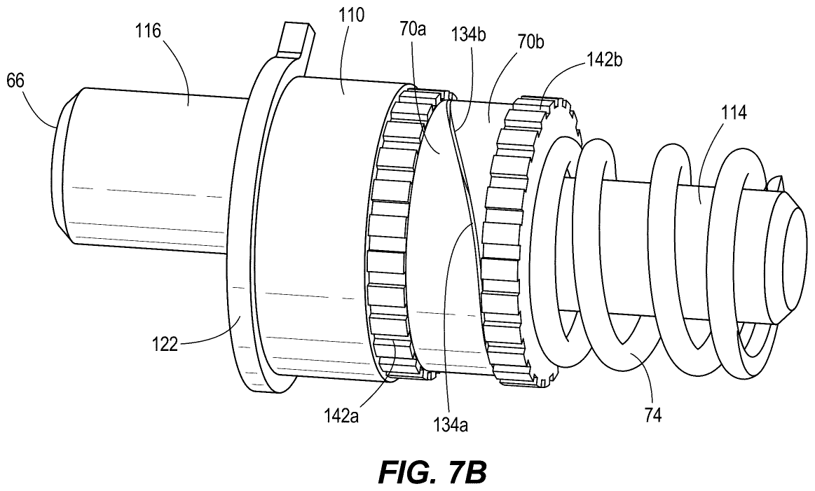

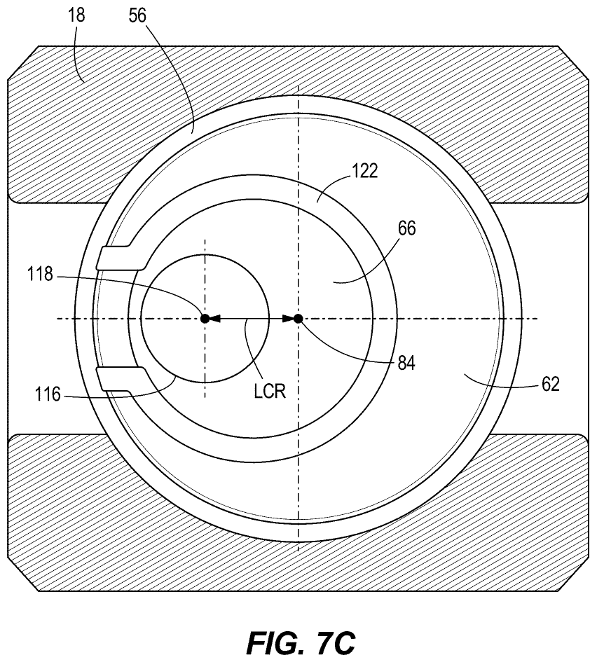

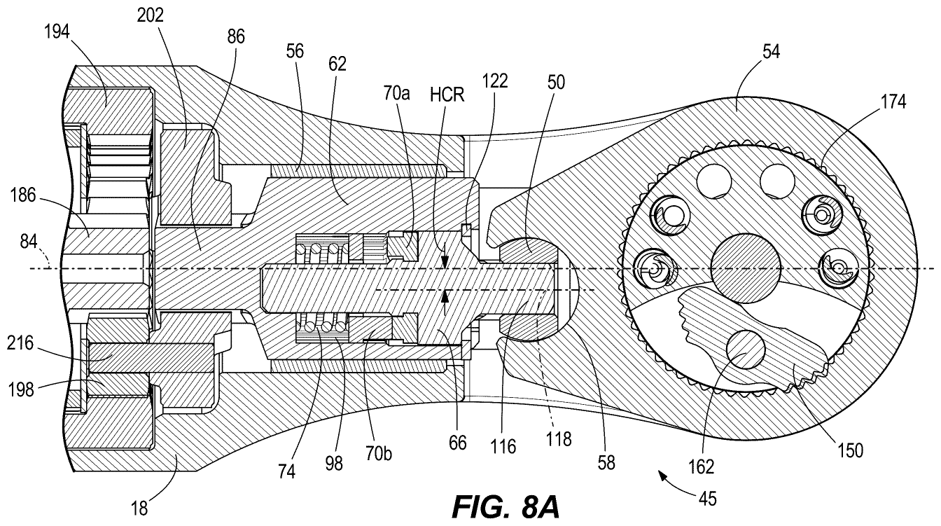

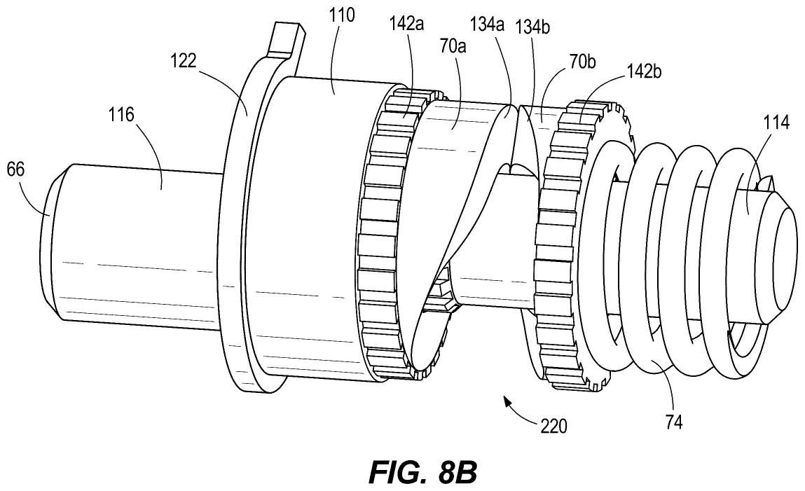

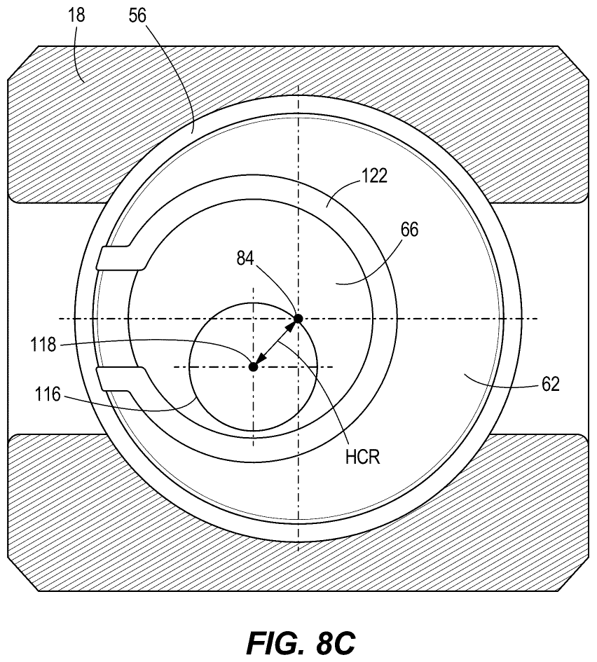

The pinion 186 extends along the first axis 30 to mesh with the plurality of planet gears 198. A plurality of pins 216 (one of the pins 216 is illustrated in FIGS. 7A and 8A) extend from the planet carrier 202 to respectively couple the plurality of planet gears 198 to the planet carrier 202. The planet carrier 202 receives the external gear 86 of the crankshaft housing 62 to be rotatably coupled to the crankshaft housing 62, and thereby transmits torque to the crankshaft assembly 46.

In other embodiments, the gear assembly 182 may be omitted from the powered ratchet tool 10 because the crankshaft assembly 46 produces sufficient torque such that no gear assembly is needed for a gear reduction. In one example, the crankshaft assembly 46 of the ratchet mechanism 45 may be directly coupled to the output shaft 26 of the motor 22. The crankshaft housing 62 and the output shaft 26 may include cooperating geometric features (e.g., splines, a key and keyway arrangement, or the like) to rotatably couple the output shaft 26 to the crankshaft housing 62, and thereby transmit torque to the crankshaft assembly 46. In another example, the crankshaft assembly 46 is operably coupled to the output shaft 26 of the motor 22 via a coupler formed as a sleeve with an internal spline configuration configured to engage the output shaft 26. The external gear 86 of the crankshaft housing 62 extends into the coupler to be coupled to the coupler for co-rotation. As such, the coupler may be sleeved onto the output shaft 26 and the crankshaft housing 62 to transmit torque to the crankshaft assembly 46.

In operation, the user engages the actuator 42 to energize the motor 22 and rotate the output shaft 26 about the first axis 30. When utilizing the actuator 42, the user may operate the powered ratchet tool 10 at a desired output torque or torque value. Rotation of the output shaft 26 causes the pinion 186 to rotate and engage the plurality of planet gears 198. The pinion 186 drives rotation of the planet gears 198 such that the planet carrier 202 also rotates about the first axis 30. The crankshaft assembly 46 is then rotated to drive rotation of the drive bushing 50 for engagement with the yoke 54. As the drive bushing 50 is rotated by the eccentric pin 116, the yoke 54 is pivoted in a reciprocating manner relative to the yoke housing 18. The yoke 54 then transfers torque to the output drive 34 to either tighten or loosen workpiece.

With reference to FIGS. 7A-7C, the powered ratchet tool 10 is operated at a low torque value. In this case, the first cam member 70a is proximate the second cam member 70b as the crankshaft assembly 46 is rotated. In some embodiments, the first and second cam members 70a, 70b may engage each other such that the ramped surfaces 134a, 134b contact each other. In other embodiments, a small gap may be provided between the ramped surfaces 134a, 134b of the cam members 70a, 70b. As a result of the cam members 70a, 70b being proximate, the eccentric pin 116 of the crankshaft 66 is positioned to produce a low torque crank radius LCR defined between the crankshaft axis 84 and the pin axis 118. Therefore, when the eccentric pin 116 rotates the drive bushing 50 to pivot the yoke 54 relative to the yoke housing 18, the yoke 54 may reach a maximum stroke position (e.g., the end of a rotational stroke achievable by the yoke 54; FIG. 7A) or may have a long rotational stroke.

With reference to FIGS. 8A-8C, the powered ratchet tool 10 is operated at a high torque value. In this case, the first and second cam members 70a, 70b are displaced relative to each other to define a substantial gap 220 therebetween as the crankshaft assembly 46 is rotated. The displacement of the cam members 70a, 70b causes the eccentric pin 116 of the crankshaft 66 to be moved in a direction towards the crankshaft axis 84. As such, the position of the eccentric pin 116 produces a high torque crank radius HCR defined between the crankshaft axis 84 and the pin axis 118. The high torque crank radius HCR is smaller than the low torque-crank radius LCR. In other words, the eccentric pin 116 is positioned closer to the crankshaft axis 84 when the ratchet tool 10 is operated at the high torque value than when the ratchet tool 10 is operated at the low torque value. When the eccentric pin 116 rotates the drive bushing 50 to pivot the yoke 54 relative to the yoke housing 18, the yoke 54 may reach a minimum stroke position (e.g., the yoke 54 pivots to a stroke position proximate the first axis 30; FIG. 8A) or have a short rotational stroke.

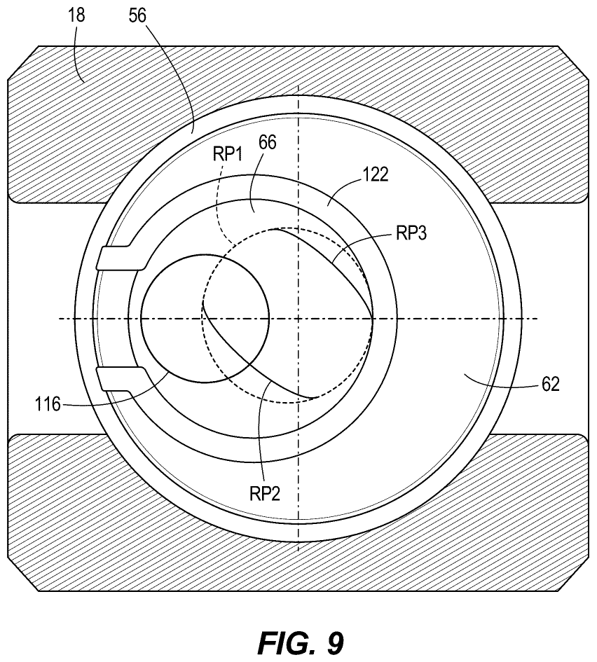

With reference to FIG. 9, various rotational paths of the eccentric pin 116 of the crankshaft 66 are illustrated. A first rotational path RP1 of the eccentric pin 116 is produced when operating the ratchet tool 10 at the low torque value. The low torque crank radius LCR radially defines the first rotational path RP1. A second rotational path RP2 and a third rotational path RP3 of the eccentric pin 116 is produced when the ratchet tool 10 is operated at the high torque value. The high torque crank radius HCR radially defines the second rotational path RP2 and the third rotational path RP3. In particular, the second rotational path RP2 is produced when the output drive 34 rotates in a clockwise direction or a first direction. The third rotational path RP3 is produced when the output drive 34 rotates in a counterclockwise direction or a second direction opposite the first direction. The eccentric pin 116 rotates closer to the crankshaft axis 84 when traveling along the second and third rotational paths RP2, RP3 than when traveling along the first rotational path RP1. As such, the crank radius CR defined between the pin axis 118 and the crankshaft axis 84 decreases as the operating torque increases and the crank radius CR increases as the operating torque decreases. The variable crank radius is then able to change an extent of each rotational stroke of the yoke 54.

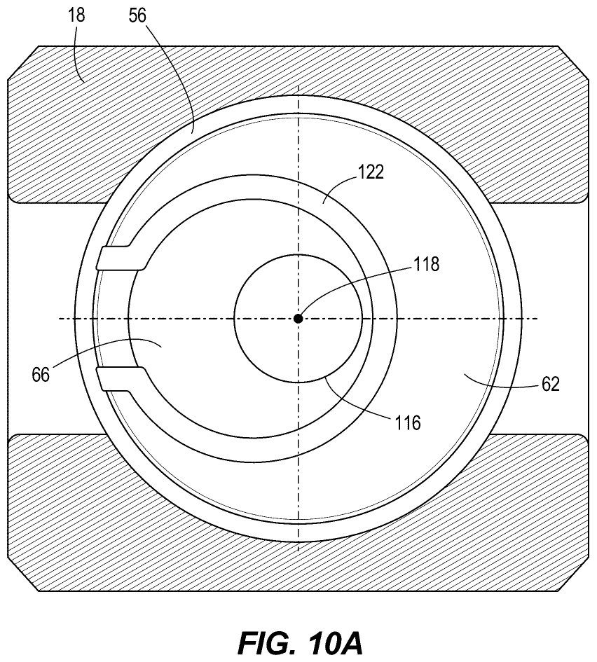

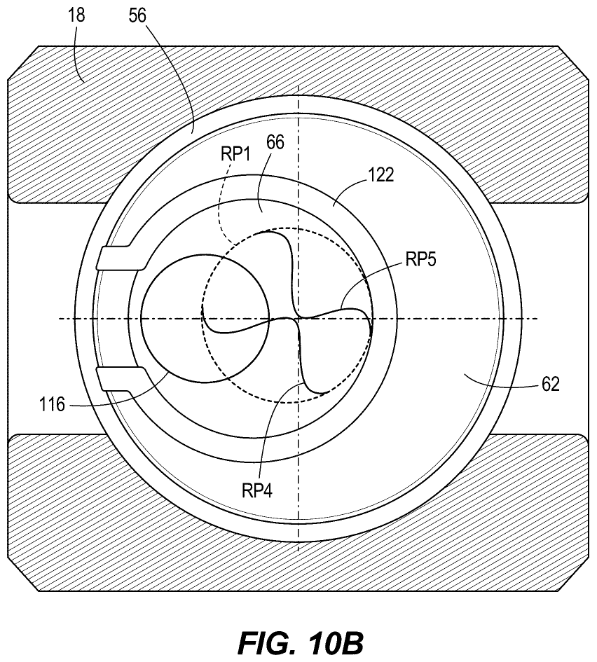

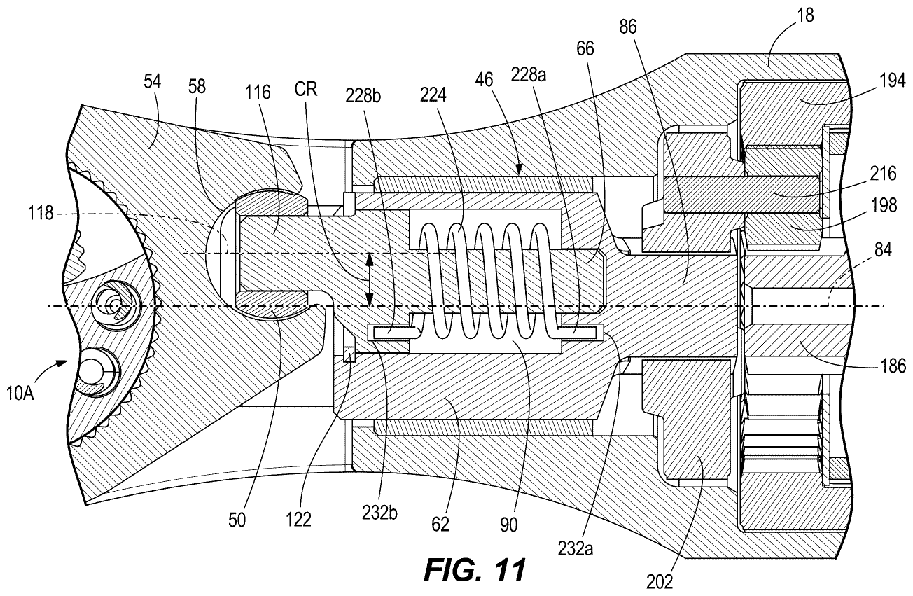

With reference to FIGS. 10A and 10B, the crankshaft assembly 46 is in a clutch state. In the clutch state, the powered ratchet tool 10 has reached a maximum torque value during operation. The cam members 70a, 70b are displaced relative to each other, and thereby move the eccentric pin 116 of the crankshaft 66 to a central region of the crankshaft housing 62 to be closely located to the crankshaft axis 84. When the crankshaft assembly 46 rotates during operation, the eccentric pin 116 and the drive bushing 50 are rotated within the recess 58 of the yoke 54 so that the drive bushing 50 does not drivingly engage the yoke 54. As such, the crankshaft assembly 46 operates as a clutch mechanism to maintain an inertia of the motor 22 for a higher torque, rather than generate a stalling operation. A fourth rotational path RP4 and a fifth rotational path RP5 of the eccentric pin 116 is produced when the ratchet tool 10 is operated at the maximum torque value. In particular, the fourth rotational path RP4 is produced when the output drive 34 rotates in a clockwise direction. The fifth rotational path RP5 is produced when the output drive 34 rotates in counterclockwise direction.

In another embodiment of the powered ratchet tool 10, the crankshaft assembly 46 may include a rotation limit mechanism (not shown) configured to allow the crankshaft 66 to move between a low torque mode and a high torque mode. In some embodiments, the rotational limit mechanism can be arranged along the crankshaft 66 and the crankshaft housing 62. In other embodiments, the rotational limit mechanism can be arranged along one of the cam members 70a, 70b and the crankshaft housing 62. In additional embodiments, the rotational limit mechanism can be arranged along both cam members 70a, 70b and the crankshaft housing 62. As such, the powered ratchet tool 10 may operate in the clockwise direction or the counterclockwise direction regardless of the arrangement of the rotation limit mechanism.

FIG. 11 illustrates a powered ratchet tool 10A according to another embodiment. The powered ratchet tool 10A is similar to the powered ratchet tool 10 of FIGS. 1-10B. As such, the following description focuses on differences between the powered ratchet tool 10A and the powered ratchet tool 10. Features of the powered ratchet tool 10A corresponding with features of the powered ratchet tool 10 are given identical reference numbers.

The illustrated powered ratchet tool 10A includes a crankshaft assembly 46 having a crankshaft carrier or crankshaft housing 62, a crankshaft 66, and a torsion spring 224 arranged between the crankshaft housing 62 and the crankshaft 66. The torsion spring 224 has a first leg 228a coupled to the crankshaft housing 62 and a second leg 228b coupled to the crankshaft 66. First and second recesses 232a, 232b are respectively defined within the crankshaft housing 62 and the crankshaft 66. As such, the first recess 232a is configured to receive the first leg 228a and the second recess 232b is configured to receive the second leg 228b. The torsion spring 224 is configured to bias the crankshaft 66.

When the powered ratchet tool is operated at a low torque value, the torsion spring 224 biases the crankshaft 66 such that an eccentric pin 116 of the crankshaft 66 is positioned to arrange a pin axis 118 away from a crankshaft axis 84 to increase a crank radius CR. When the eccentric pin 116 rotates the drive bushing 50 to pivot the yoke 54 relative to the yoke housing 18, the yoke 54 may reach a maximum stroke position or may have a long rotational stroke. When the powered ratchet tool 10A is operated at a high torque value, the torsion spring 224 compresses such that the eccentric pin 116 of the crankshaft 66 is moved in a direction towards the crankshaft axis 84 to decrease the crank radius CR. When the eccentric pin 116 rotates the drive bushing 50 to pivot the yoke 54 relative to the yoke housing 18, the yoke 54 may reach a minimum stroke position or have a short rotational stroke.

Although the disclosure has been described in detail with reference to certain preferred embodiments, variations and modifications exist within the scope and spirit of one or more independent aspects of the disclosure as described.

Various features and aspects of the present disclosure are set forth in the following claims.

What is claimed is:

1. A powered ratchet tool comprising:
a housing;
a motor disposed within the housing, the motor including an output shaft rotatable about a first axis;
a ratchet mechanism supported by the housing and operably coupled to the output shaft to be driven by the motor, the ratchet mechanism including a crankshaft assembly defining a variable crank radius configured to change an extent of each rotational stroke of the ratchet mechanism; and
an output drive operably coupled to the ratchet mechanism to be rotated about a second axis perpendicular to the first axis.

2. The powered ratchet tool of claim 1, wherein the variable crank radius decreases as a torque value of the powered ratchet tool increases to provide a short rotational stroke of the ratchet mechanism, and wherein the variable crank radius increases as the torque value of the powered ratchet tool decreases to provide a long rotational stroke.

3. The powered ratchet tool of claim 1, wherein the crankshaft assembly includes
a crankshaft housing operably coupled to the output shaft of the motor for co-rotation about the first axis, and
a crankshaft at least partially disposed within a cavity defined within the crankshaft housing, the crankshaft having an eccentric pin defining a pin axis offset from the first axis, and wherein the variable crank radius is defined between the first axis and the pin axis.

4. The powered ratchet tool of claim 3, wherein the crankshaft assembly further includes a cam mechanism disposed within the cavity of the crankshaft housing, the cam mechanism configured to move the crankshaft for increasing or decreasing the variable crank radius.

5. The powered ratchet tool of claim 4, wherein the cam mechanism includes a first cam member and a second cam member configured to be displaced relative to each other to move the crankshaft.

6. The powered ratchet tool of claim 5, wherein the first cam member is coupled to the crankshaft and the second cam member is coupled to the cavity of the crankshaft housing.

7. The powered ratchet tool of claim 6, wherein the first cam member and the crankshaft have cooperating spline patterns, and wherein the second cam member and the cavity have cooperating spline patterns.

8. The powered ratchet tool of claim 5, wherein the crankshaft assembly further includes a biasing member disposed within the cavity of the crankshaft housing, the biasing member configured to bias the first cam member and the second cam member into engagement.

9. The powered ratchet tool of claim 3, wherein the crankshaft assembly further includes a torsion spring configured to rotationally bias the crankshaft relative to the crankshaft housing.

10. A powered ratchet tool comprising:
a housing;
a motor disposed within the housing, the motor including an output shaft rotatable about a first axis;
a crankshaft assembly supported by the housing, the crankshaft assembly including
a crankshaft housing operably coupled to the output shaft of the motor for co-rotation about the first axis, and
a crankshaft at least partially disposed within the crankshaft housing, the crankshaft having an eccentric pin offset from the first axis, the eccentric pin configured to travel along a first rotational path during operation at a first torque and a second rotational path during operation at a second torque greater than the first torque, the eccentric pin rotates closer to the first axis when traveling along the second rotational path than when traveling along the first rotational path; and
an output drive operably coupled to the crankshaft assembly to be rotated about a second axis perpendicular to the first axis.

11. The powered ratchet tool of claim 10, wherein the eccentric pin is configured to travel along a third rotational path during operation at the second torque such that the eccentric pin rotates closer to the first axis when traveling along the third rotational path than when traveling along the first rotational path.

12. The powered ratchet tool of claim 11, wherein the eccentric pin travels along the second rotational path when the output drive rotates in a first direction, and the eccentric pin travels along the third rotational path when the output drive rotates in a second direction opposite the first direction.

13. The powered ratchet tool of claim 11, wherein the eccentric pin is configured to travel along a fourth rotational path during operation at a maximum torque such that the eccentric pin moves to a central region of the crankshaft housing, and wherein the crankshaft assembly is in a clutch state during operation at the maximum torque.

14. A powered ratchet tool comprising:
a housing;
a motor disposed within the housing, the motor including an output shaft rotatable about a first axis;
a ratchet mechanism supported by the housing and operably coupled to the output shaft to be driven by the motor, the ratchet mechanism including a crankshaft assembly having
a crankshaft with an eccentric pin offset from the first axis, and
at least two cam members configured to move relative to each other to change a position of the eccentric pin relative to the first axis, and thereby change an extent of each rotational stroke of the ratchet mechanism; and
an output drive operably coupled to the crankshaft assembly to be rotated about a second axis perpendicular to the first axis.

15. The powered ratchet tool of claim 14, wherein the at least two cam members are configured to move between a first position, in which the at least two cam members are proximate each other, and a second position, in which a gap is defined between the at least two cam members.

16. The powered ratchet tool of claim 15, wherein in the first position, the eccentric pin is positioned relative to the first axis such that the ratchet mechanism reaches a maximum stroke position, and wherein the second position, the eccentric pin is positioned relative to the first axis such that the ratchet mechanism reaches a minimum stroke position.

17. The powered ratchet tool of claim 14, wherein the crankshaft assembly further includes a spring configured to bias the at least two cam members to be proximate each other.

18. The powered ratchet tool of claim 14, wherein the ratchet mechanism further includes a drive bushing coupled to the eccentric pin of the crankshaft and a yoke having a recess in which the drive bushing is arranged to operably couple the crankshaft assembly to the yoke.

19. The powered ratchet tool of claim 18, wherein the output drive extends through the yoke.

20. The powered ratchet tool of claim 14, further comprising a sleeve bearing configured to rotatably support the crankshaft assembly.
